(19) United States
(12) Patent Application Publication
(10) Pub. No.: US 2005/0247362 A1
(43) Pub. Date: Nov. 10, 2005

(54) Well hose with embedded electrical conductors

(76) Inventors: Robert Harcourt, Erie, PA (US); Mark Lockhart, Waterford, PA (US)

Correspondence Address: KENNETH L. MITCHELL (WOODLING, KROST AND RUST), 9213 CHILLICOTHE ROAD, KIRTLAND, OH, 44094, US

(21) Appl. No.: 10/841,793

(22) Filed: May 7, 2004

(51) Int. Cl. F16L 11/00

(52) U.S. Cl. 138/125

(57) ABSTRACT

A hose which includes an inner tube having an inside and an outside, with adhesive affixed to the outside of the inner tube is disclosed. At least one electrical conductor is embedded in the adhesive. The conductor(s) may be used for the transmission of signals or for the supply of electrical energy. A woven outer jacket resides outside the inner tube and the inner tube is secured to the outer tube by heat-activated adhesive. A process for making the hose is also disclosed and claimed. Another embodiment includes securing a wire or wires to the exterior of a composite hose by applying a hot-melted thermoplastic material over the entire circumference of the composite hose. Still another embodiment discloses application of the thermoplastic material selectively over the wires only, and not the entire outer circumference of the outer jacket.

### FIELD OF THE INVENTION

The invention is in the field of hoses having electrical lines therein.

### BACKGROUND OF THE INVENTION

U.S. Pat. No. 5,109,534 to Naito et al. illustrates a cable communication system with a transmission line incorporated in the hose. The specification of the '534 patent states at column 6, lines 27 et seq., “[t]he communication line-incorporated water hose 3 is comprised, as typically shown in FIGS. 3(A) and (B), of a tubular hose jacket 26 and a lining tube of a plastic resin or a rubber 27 lined upon the interior surface of the hose jacket 26, and there is an electric cable 28 disposed in sandwiched fashion between the hose jacket 26 and the lining tube.” The specification of the '534 patent describes the electric cable as a coaxial cable which has the ability to stretch without failing. Drawing FIGS. 3(A) and 3(B) of the '534 patent have been reproduced as drawing FIGS. 1 and 2 of the instant application.

FIG. 1 is a cross-sectional longitudinal view 1 of the prior art as disclosed in U.S. Pat. No. 5,109,534 to Naito et al. FIG. 2 is a cross-sectional transverse view 2 taken along the lines A-A of FIG. 1 as disclosed in U.S. Pat. No. 5,109,534 to Naito et al.

The '534 patent, in regard to electric cable 28, is silent as to its construction other than to recite that it is disposed in sandwiched fashion between the tubular hose jacket 26 and the lining tube. Apparently the coaxial cable of the '534 patent enables communication and control and does not pertain to the transfer of power. No adhesive is disclosed in the teachings of the '534 patent.

Other patents indicating the state of the art are: U.S. Pat. No. 6,666,274 B2; U.S. Pat. No. 5,713,864; U.S. Pat. No. 6,392,317; U.S. Pat. No. 5,637,168;U.S. Pat. No. 3,899,631; U.S. Pat. No. 5,932,842; U.S. Pat. No. RE37,775 E; U.S. Pat. No. 5,267,670; U.S. Pat. No. 5,442,810; U.S. Pat. No. 6,668,934 B2; U.S. Pat. No. 6,296,066 B1; U.S. Pat. No. 6,235,232 B1; U.S. Pat. No. 4,098,342; U.S. Pat. No. 3,285,629; U.S. Pat. No. 3,378,811; and U.S. Pat. No. 4,229,613.

Endot Industries discloses a potable water pipe and an outer sheath made from polyethylene with conductors located therearound in a sheath.

It is desirable to utilize a woven jacketed hose having electrical conductors contained therein in a water well application such that the conductors enable communication and power transfer to a pump in the well. It is also desirable to have conductors absorb and resist torque applied to the pump motor.

### SUMMARY OF THE INVENTION

A plurality of conductors is affixed by adhesive previously applied to the exterior of a polyurethane tube. The conductors and the polyurethane tube are then placed inside a woven outer jacket. The woven outer jacket includes a latex sealant applied before the polyurethane tube is inserted therein. Pressurized and heated by steam the polyurethane tube expands against the woven outer jacket and activates the adhesive which secures the polyurethane to the woven outer jacket.

The process for making the hose includes the following steps: weaving the outer jacket; applying latex coating onto, into and through the outer jacket; removing excess coating from the coated outer jacket; curing the latex coated outer jacket; forming a polyurethane tube; applying adhesive to the exterior of the polyurethane tube; attaching conductors to the polyurethane tube; inserting the polyurethane tube in said outer jacket; and, applying steam to the interior of said polyurethane tube.

Alternatively, the steps of affixing wires to the outside of the woven jacket and then passing the composite hose through an extruder to secure the wires may be employed. Still alternatively, the steps of passing the woven jacket through a secondary extruder to selectively apply molten polyurethane locally over the wires may be employed.

Other embodiments of the invention are directed to placement of the conductors (wires) on the exterior of the composite hose. A thermoplastic material is extruded onto the exterior of the hose and secures the conductors to the exterior of the hose. The extrusion may extend around the circumference of the exterior of the hose. The extrusion may, alternatively, be selectively applied just over the conductors where they reside adjacent the exterior of the hose. The conductors add rigidity and resistance to counteract pump motor torque.

It is an object of the present invention to provide a hose or a series of hoses having conductors therein for the transmission of electrical power to an electric motor such as a pump motor.

It is a further object of the present invention to provide a hose having conductors therein where said conductors are adhesively affixed to a polyurethane liner.

It is a further object of the present invention to provide a hose having a woven outer jacket and conductors therein.

It is a further object of the present invention to provide a water hose having electrical conductors therein for use in combination with a well pump.

It is a further object of the present invention to provide a water hose having electrical conductors which provide rigidity against pump motor torque when the hose is affixed to a pump motor.

It is a further object of the present invention to provide a water hose having electrical conductors affixed to the exterior of the hose. The conductors may be affixed by a thermoplastic material applied to the entire exterior circumference of the composite hose or the thermoplastic material may only be applied locally over the wire(s) to be affixed to the hose.

These and other objects will be better understood when reference is made to the Brief Description of the Drawings, Description of the Invention, and Claims which follow hereinbelow.

### BRIEF DESCRIPTION OF THE DRAWINGS

FIG. 1 is a cross-sectional longitudinal view of the prior art as disclosed in U.S. Pat. No. 5,109,534 to Naito et al.

FIG. 2 is a cross-sectional transverse view of the prior art as disclosed in U.S. Pat. No. 5,109,534 to Naito et al.

FIG. 3 is an illustration of the process steps for manufacturing the present invention.

FIG. 3A is an illustration of the process steps for manufacturing another embodiment of the present invention.

FIG. 3B is an illustration of the process steps for manufacturing another embodiment of the present invention.

FIG. 4 is a perspective view of the woven outer jacket of the present invention.

FIG. 5 is a schematic illustration for dipping the woven outer jacket of the present invention in a latex coating.

FIG. 5A is cross-sectional view of the outer jacket being drawn through a wiper assembly to remove excess latex from the outer jacket.

FIG. 5B is a cross-sectional view taken along the lines 5B-5B of FIG. 5A illustrating the hose having latex on, in and through the woven outer jacket.

FIG. 5C is a schematic of the latex curing process.

FIG. 6 is a perspective view of the polyurethane tube.

FIG. 6A is a view of the polyurethane tube laid flat.

FIG. 7 is a perspective view of a polyurethane tube with adhesive being sprayed thereon.

FIG. 7A is a view of the laid-flat polyurethane tube of FIG. 6A with adhesive being applied thereto.

FIG. 8 is a perspective view of the polyurethane tube of FIG. 7 with four conductors affixed thereto.

FIG. 8A is a top view of FIG. 8.

FIG. 8B is a front view of FIG. 8.

FIG. 8C is a view similar to FIG. 8A only the conductors aren't insulated.

FIG. 8D is a view similar to FIG. 8A only coaxial conductors are utilized.

FIG. 8E is a view of the laid-flat hose with conductors applied thereto.

FIG. 9 illustrates the polyurethane tube partially inserted into the woven outer jacket.

FIG. 9A illustrates the polyurethane tube fully inserted into the woven outer jacket.

FIG. 9B illustrates the laid-flat polyurethane tube partially into the woven outer jacket.

FIG. 10 illustrates pressurizing the inner tube with steam.

FIG. 10A illustrates pressurizing the inner tube with steam and the use of a flange to seal the polyurethane tube.

FIG. 11 is a perspective view of the inner tube, the polyurethane tube, and the outer jacket secured with the conductors affixed between the tube and the outer jacket.

FIG. 11A is a top view of FIG. 11.

Fig. 11B is a front view of FIG. 11.

FIG. 11C is an enlargement of a portion of FIG. 11A illustrating adhesive between the inner tube and the conductors and between the inner tube and the outer jacket.

Fig. 11D is a cross-sectional view of another embodiment of composite hose made by the process illustrated in FIG. 3A illustrating adhesive applied over conductors on the exterior of a composite hose.

Fig. 11E is a cross-sectional view of another embodiment of composite hose made by the process illustrated in FIG. 3B illustrating a hot-melted polyurethane or polyethylene bonded and applied over the conductors securing the conductors to the outside of the hose.

FIG. 12 is an illustration of the hose used in combination with a well casing and a well pump.

FIG. 12A is an illustration of a hose union which enables the joinder of two sections of hose together.

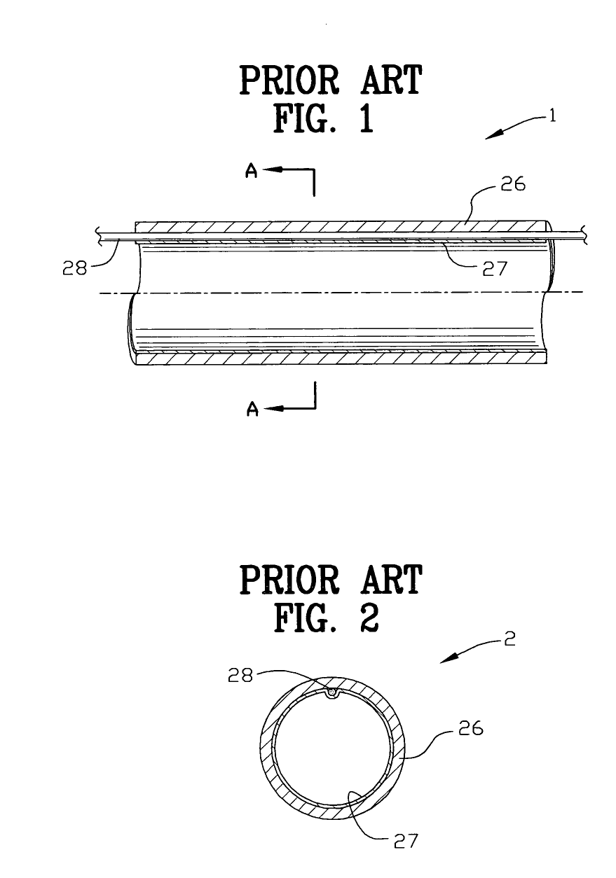

The drawings will be better understood when reference is made to the Description of the Invention and Claims which follow hereinbelow.

### DESCRIPTION OF THE INVENTION

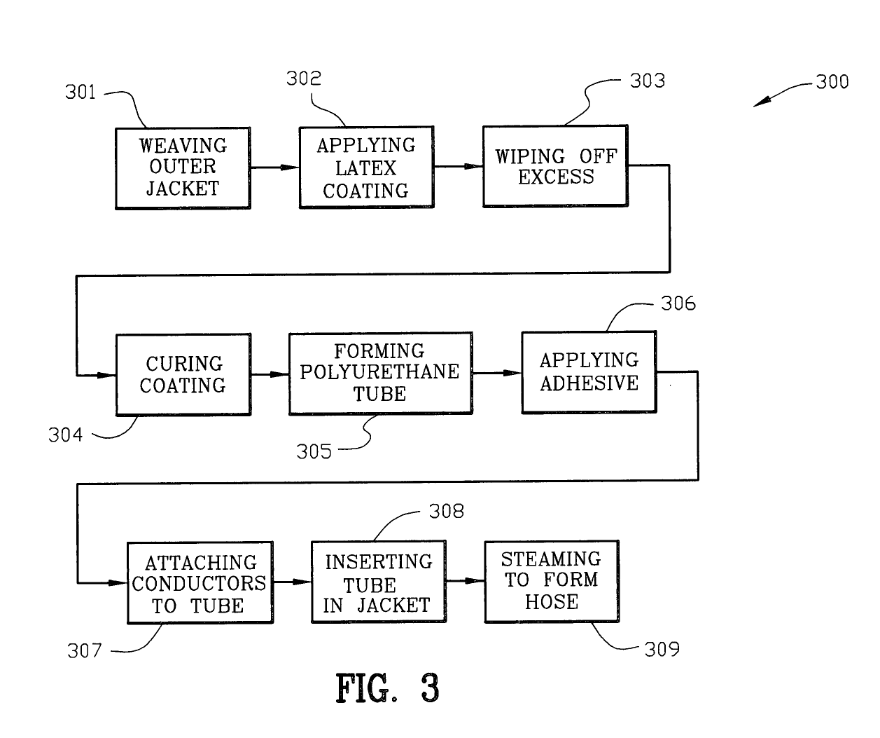

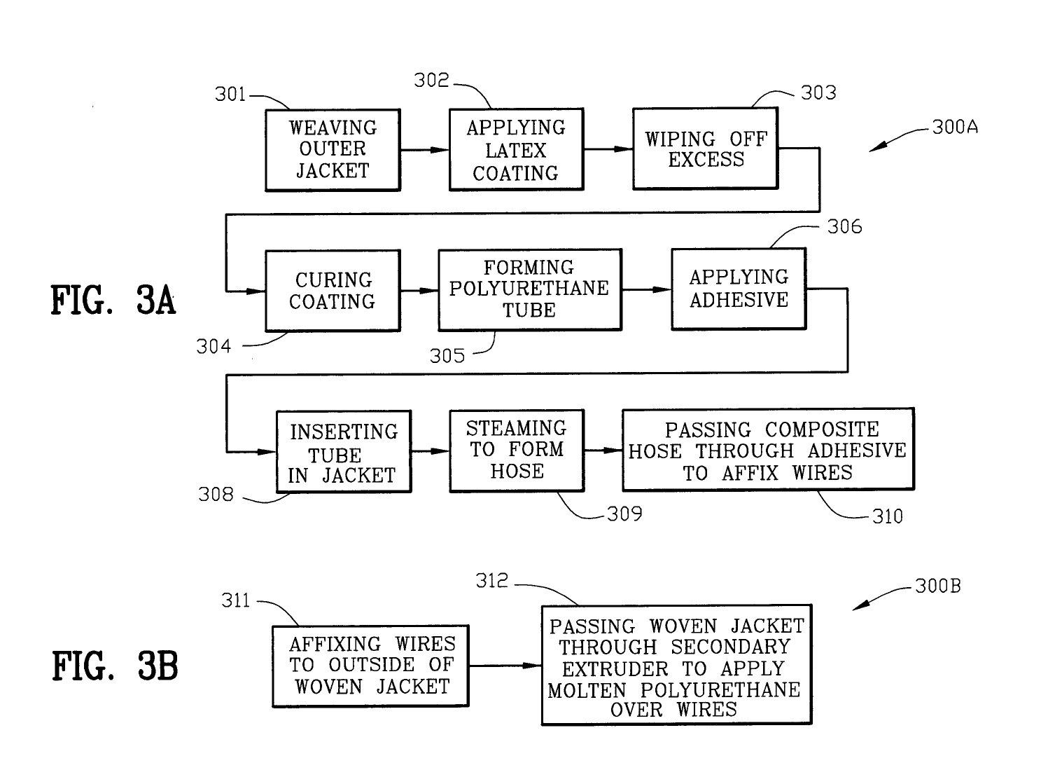

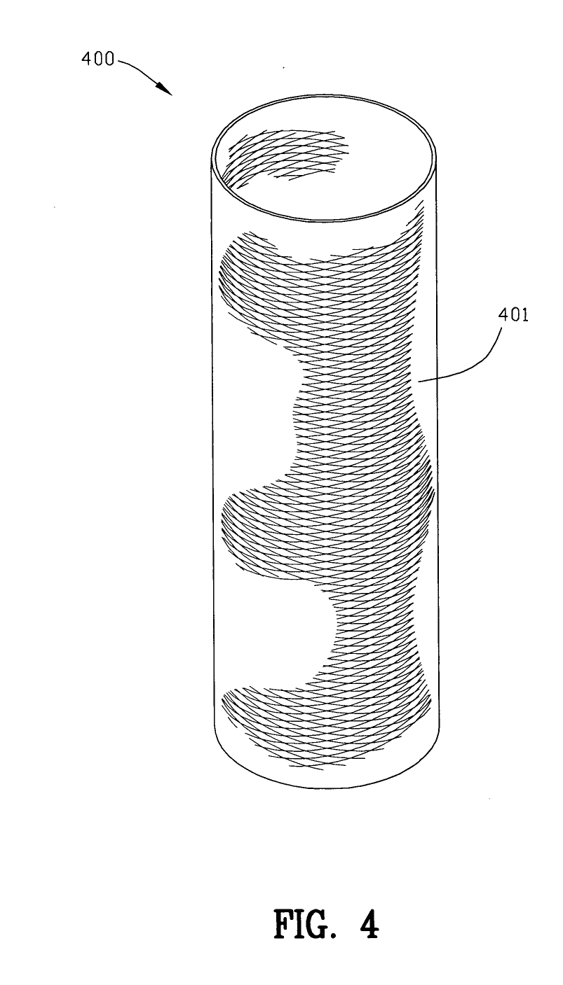

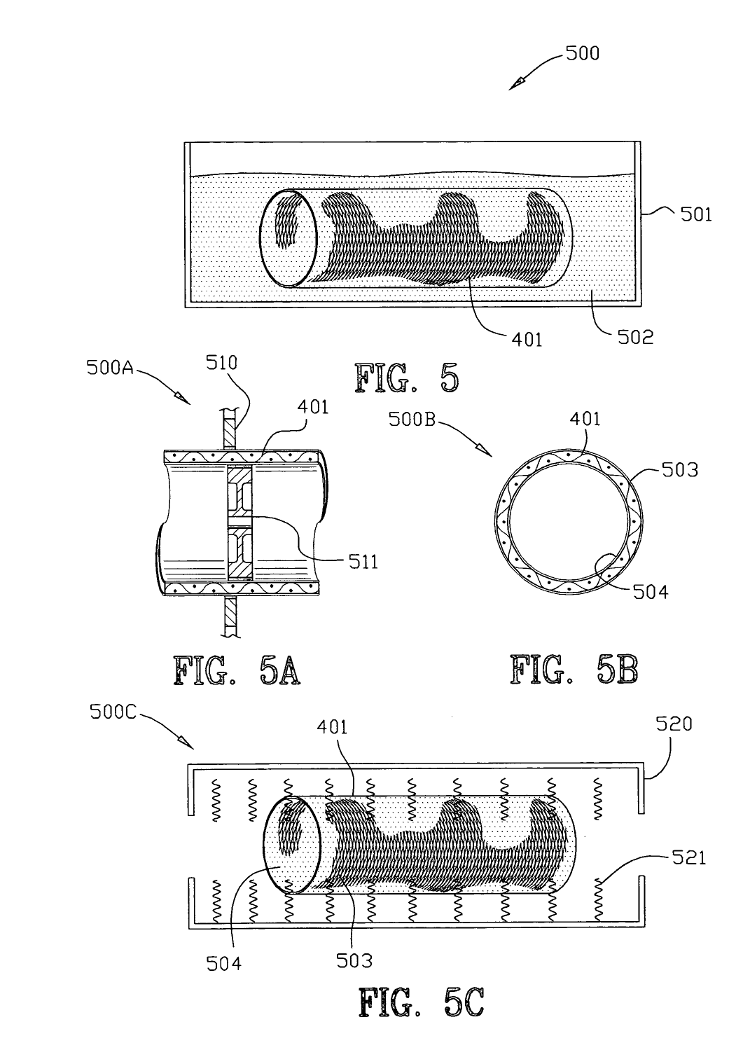

FIG. 3 is an illustration 300 of the process steps of the present invention. The first step is weaving 301 an outer jacket and then applying 302 a latex sealant onto, into and through the outer jacket 401. FIG. 4 is a perspective view 400 of the woven outer jacket 401 of the present invention. FIG. 5 is a schematic illustration for dipping 500 the woven outer jacket of the present invention in a latex sealant bath 501. Bath 501 is filled with the latex coating 502. The outer woven jacket 401 is allowed to soak in the latex sealant bath so that the sealant is absorbed by the jacket.

FIG. 5A is cross-sectional view 500A of the outer jacket 401 being drawn through a wiper assembly to remove excess latex sealant 502 from the inside and outside of the jacket. Referring to FIGS. 3 and 5A, the woven outer jacket is wiped to remove the excess latex sealant 502 therefrom. The exterior of the woven jacket is wiped by exterior wiper 510 and the interior of the woven jacket is wiped by interior wiper 511. FIG. 5B is a cross-sectional view 500B taken along the lines 5B-5B of Fig. 5A illustrating the hose having latex on, in and through the woven outer jacket. FIG. 5B illustrates warp and weft fibers of the woven jacket 401 and also illustrates a thin layer 503 of sealant applied to the exterior of the woven outer jacket 401 and a thin layer 504 of sealant applied to the interior of the woven outer jacket 401.

After wiping 303 the excess latex sealant from the woven outer jacket, curing 304 the hose as illustrated in FIG. 5C occurs. A curing station 520 emits energy 521 to cure the latex sealant of the outer jacket. Energy 521 may in the form of heat energy or microwave energy. Fig. 5C is a schematic 500C of the latex curing process.

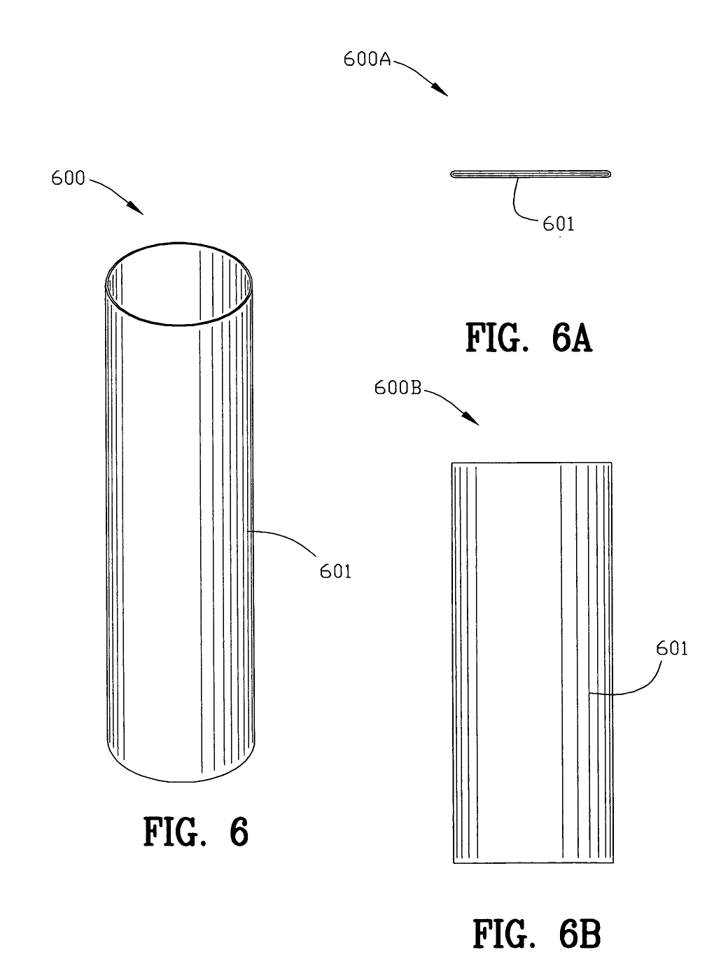

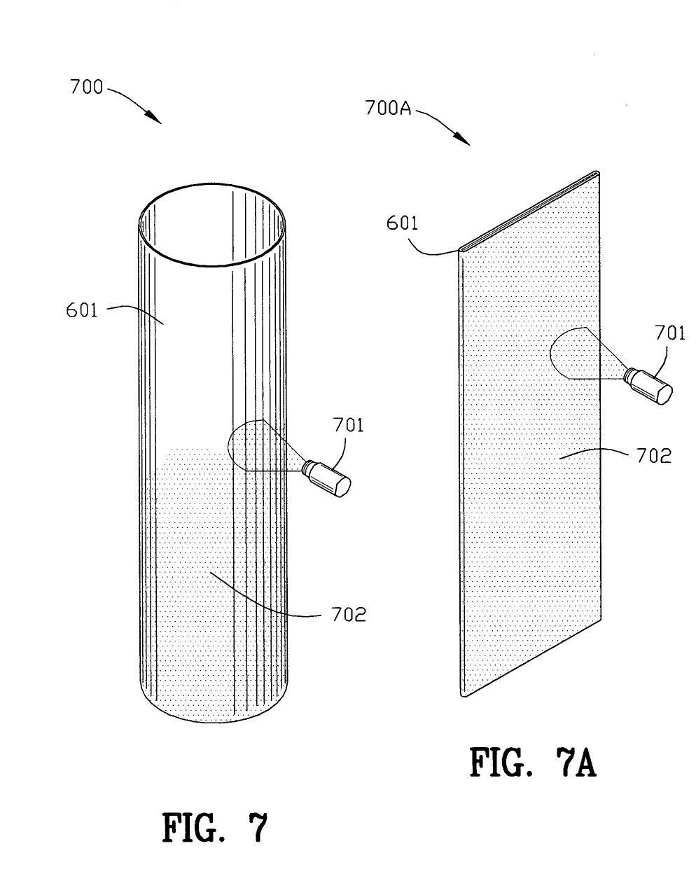

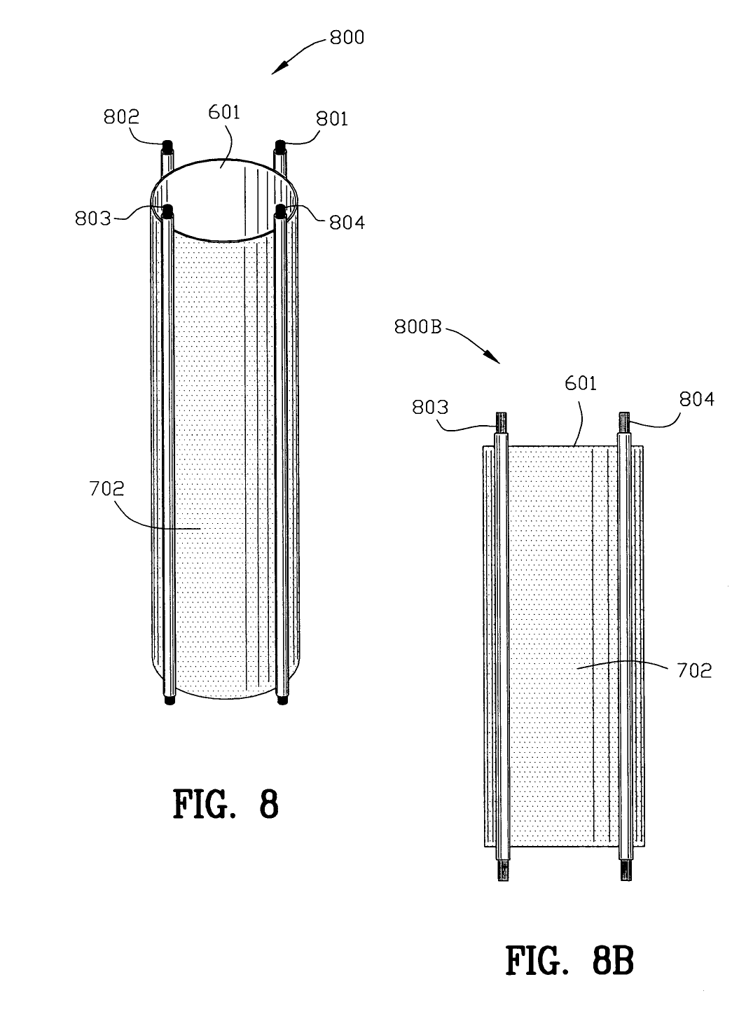

FIG. 6 is a perspective view 600 of the polyurethane tube 601. The polyurethane tube 601 is formed 305 by known tube-forming processes. FIG. 6A is a view 600A of the polyurethane tube 601 laid-flat. Preferably the laid-flat polyurethane tubular hose is employed because it slidably fits within the woven outer jacket.

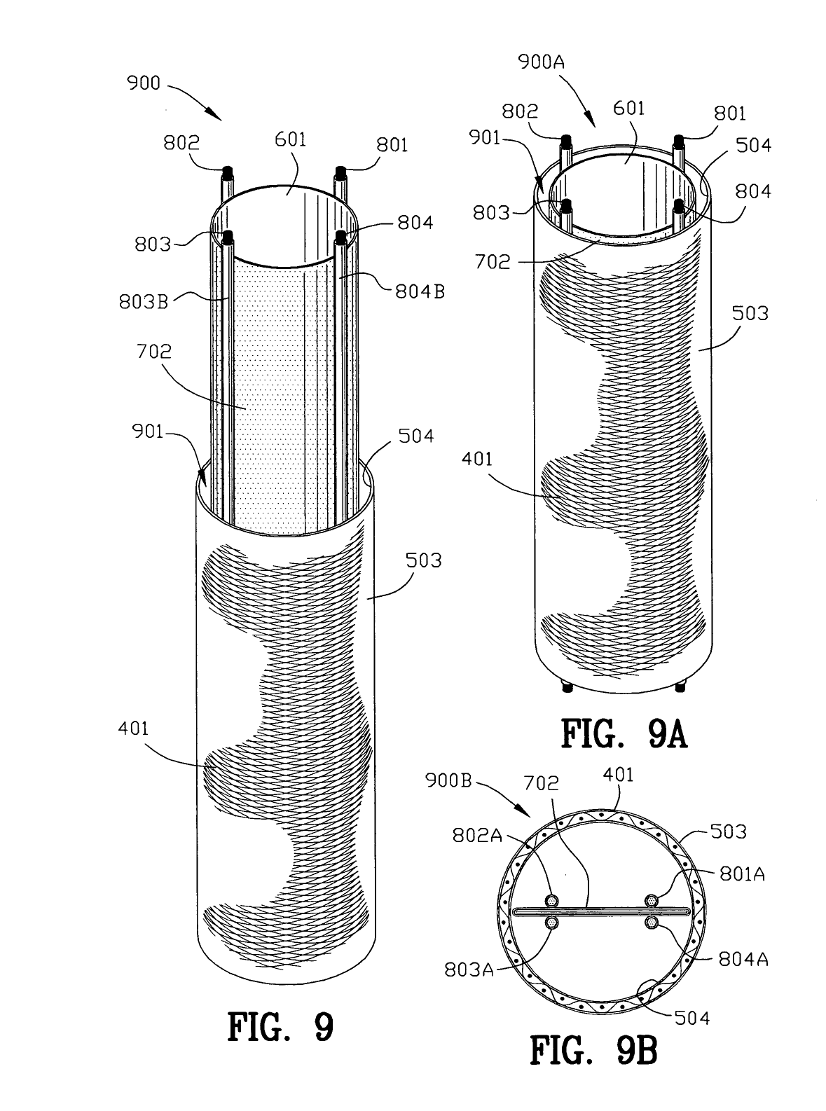

FIG. 7 is a perspective view 700 of a polyurethane tube with adhesive 702 being sprayed 701 thereon. FIG. 7A is a view of the laid-flat polyurethane tube of FIG. 6A with adhesive being sprayed 701 thereon. Preferably the adhesive 702 is a heat-activated adhesive as this enables the polyurethane tube to be placed inside the woven outer jacket 401 as illustrated in FIGS. 9, 9A and 9B. Heat-activated adhesive becomes stickier and tackier when heat is applied to it. The step of applying 306 adhesive may be performed by methods other than spraying. For instance, the adhesive may be applied with rollers or the polyurethane tube in its laid-flat condition may be submersed in a bath of adhesive.

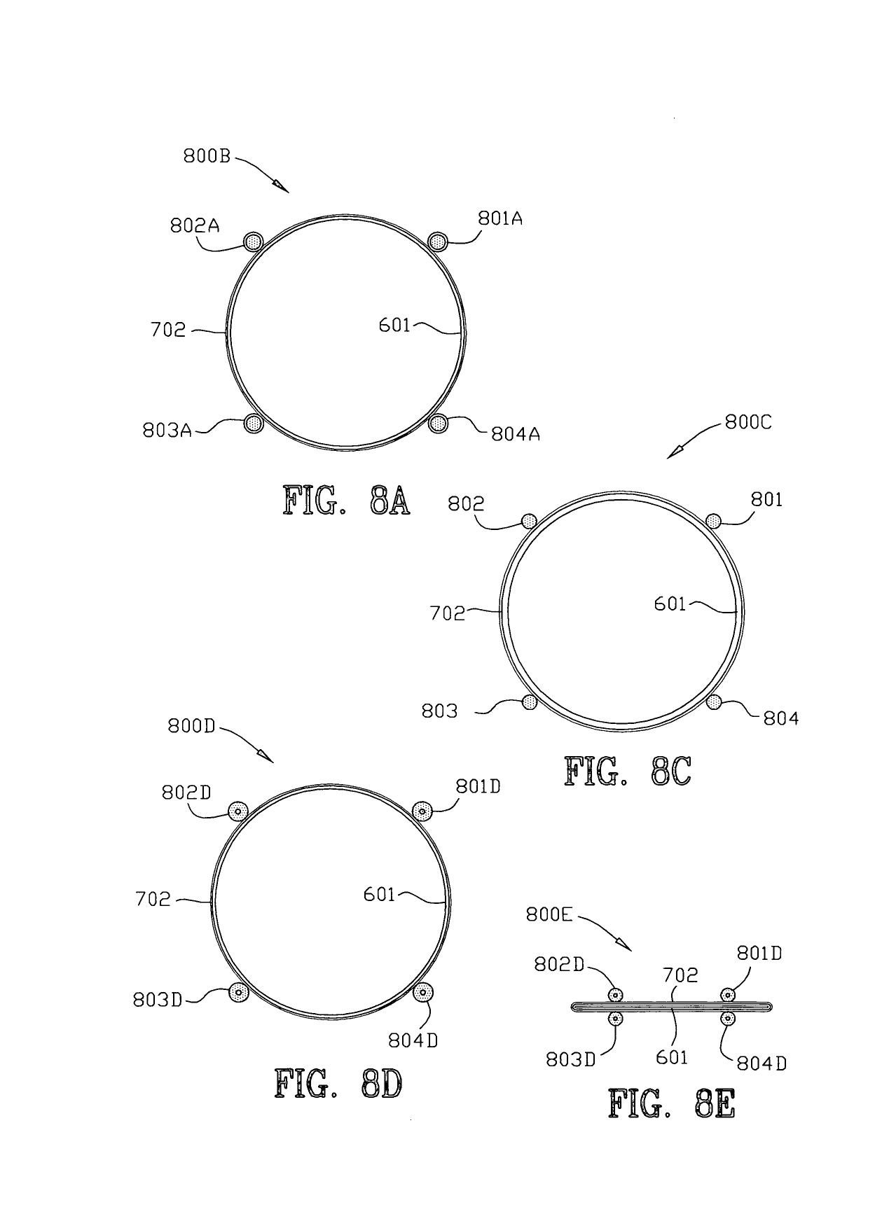

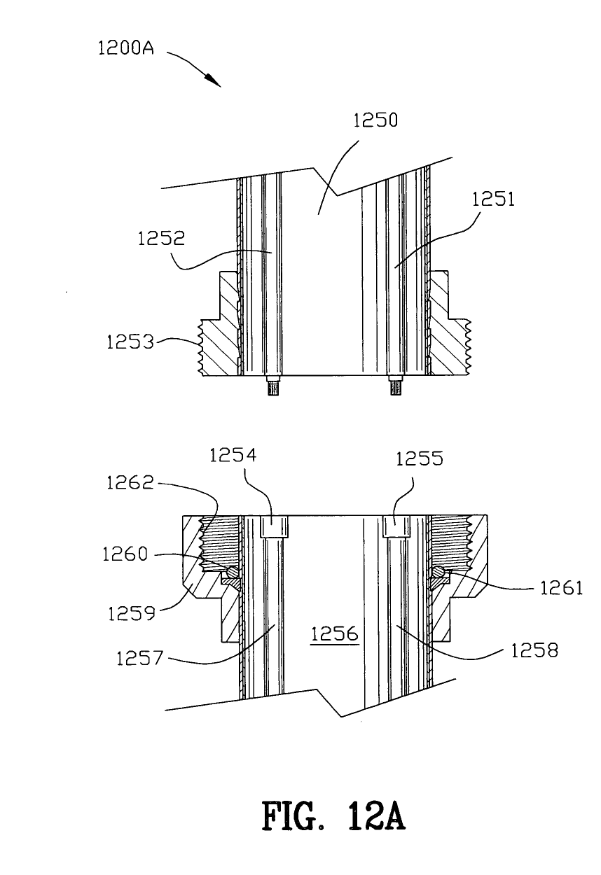

FIG. 8 is a perspective view 800 of the polyurethane tube of FIG. 7 with four conductors 801, 802, 803 and 804 affixed thereto. Attaching 307 the conductors to the polyurethane tube is preferably performed while the hose is laid-flat. See FIG. 7A which illustrates the laid-flat hose with adhesive applied thereto. The conductors are spaced 90 degrees from each other and this provides rigidity against torque of the pump motor as illustrated in FIG. 12. More or fewer conductors may be utilized. Increasing the number of conductors increases the ability of the hose to resist torque.

FIG. 8A is a top view 800A of FIG. 8 and reference numerals 801A, 802A, 803A and 804A indicate insulation around the respective conductors. FIG. 8B is a front view 800B of FIG. 8.

The conductors 801, 802, 803 and 804 are placed into engagement with the adhesive 702 of the polyurethane tube when the tube is laid-flat as illustrated in FIGS. 6A, 7A and 8E. FIG. 8C is a view similar to FIG. 8A only the conductors aren't insulated.

FIG. 8D is a view 800D similar to FIG. 8A only coaxial conductors 801D, 802D, 803D and 804D are utilized. These conductors are applied when the hose is laid flat so that the polyurethane tube may be easily inserted into the woven outer jacket. FIG. 8E is a view 800E of the laid-flat hose with the coaxial conductors applied thereto. Any conductor, insulated or non-insulated, may be applied as illustrated in FIG. 8E.

FIG. 9 is a view 900 illustrating the polyurethane tube 601 partially inserted into the woven outer jacket 401. FIG. 9A is a view 900A illustrating the polyurethane tube 401 fully inserted into the woven outer jacket. An annular gap 901 exists between the polyurethane tube 601 and the woven outer jacket 401.

Inserting 308 the polyurethane tube 601 into the outer woven jacket is performed with the conductors attached thereto. FIG. 9B is a view 900B illustrating the laid-flat polyurethane tube inserted into the woven outer jacket. While FIGS. 9 and 9A schematically illustrate the polyurethane tube 601 as concentric with the outer woven jacket 401, the installation of the polyurethane tube will preferably be in its laid-flat state as indicated in FIG. 9B. In this way, the laid-flat condition of the polyurethane hose is more conducive to insertion within the woven outer jacket.

The outer woven jacket is pulled over a metal string, rod or other similar structure and then the polyurethane hose being attached to the metal string, rod or other similar structure and is pulled through the outer woven jacket. The adhesive does not interfere with threading the polyurethane hose through the outer woven jacket because it is not yet activated.

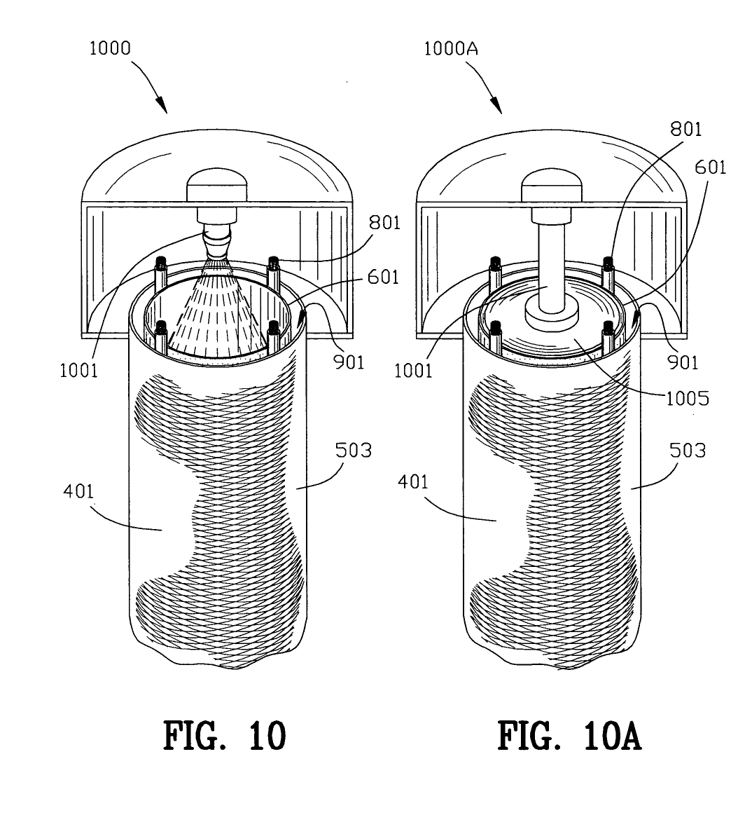

FIG. 10 is a view 1000 illustrating the pressurization of the inner polyurethane tube with steam. Nozzle or valve 1001 admits steam to the polyurethane tube 601.

In practice, the step of steaming 309 to form the hose is performed on a table. If polyurethane tube 601 is in its laid-flat state, it may have to be opened to admit the steam to its inner portion for expansion and heat activation of the adhesive. FIG. 10B is a view 1000B which illustrates the polyurethane tube 601 over a flange 1005 which admits steam to the interior of the tube. As steam is admitted to the interior of the polyurethane tube, it expands and the adhesive is activated which increases its tackiness and hence its ability to act as an adhesive. As the polyurethane tube expands it is melting to conform to the shape of the inside of the outer woven jacket.

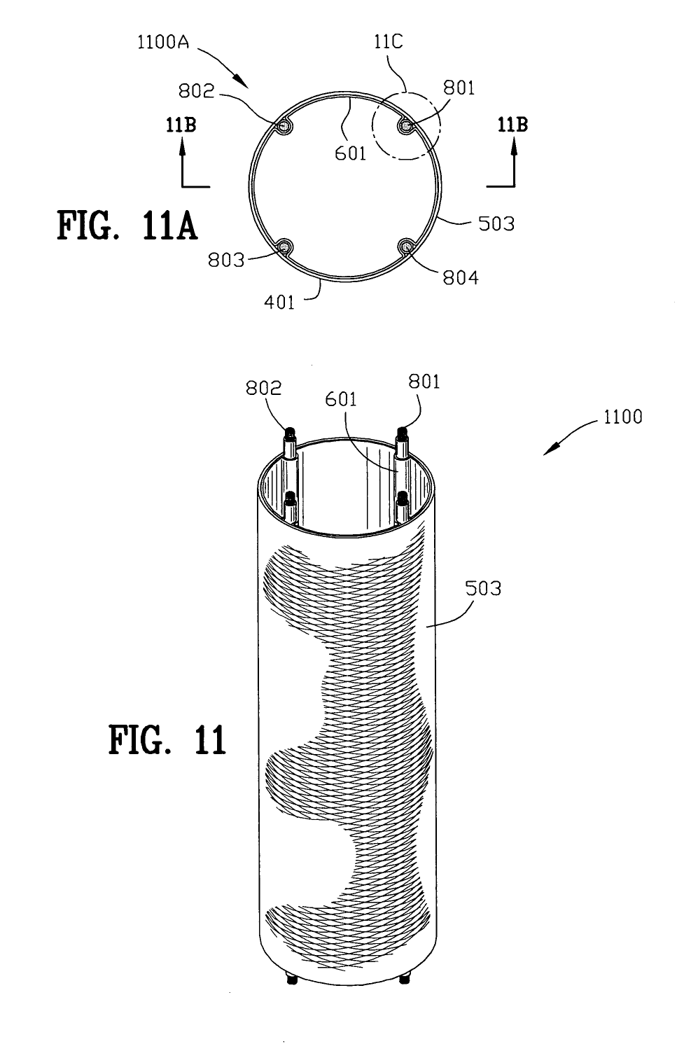

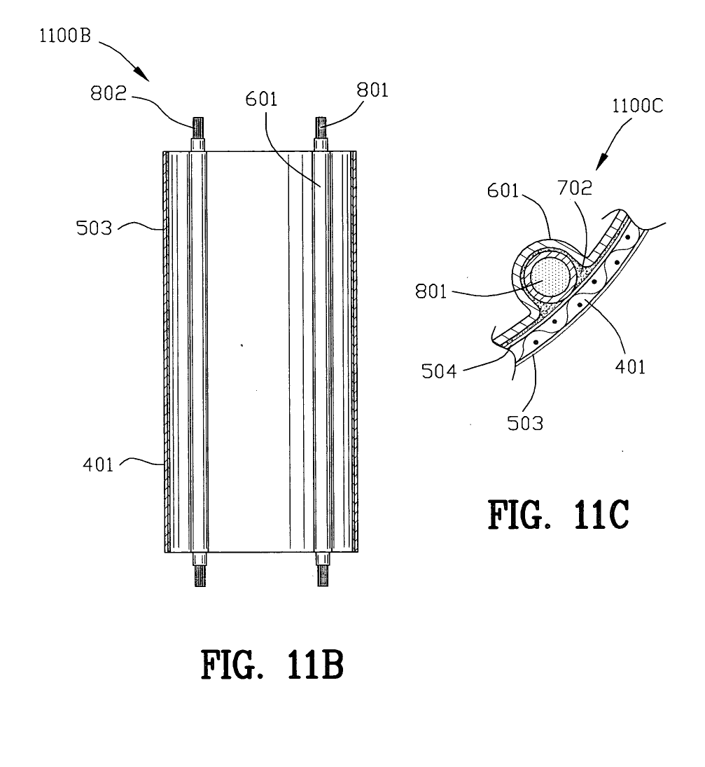

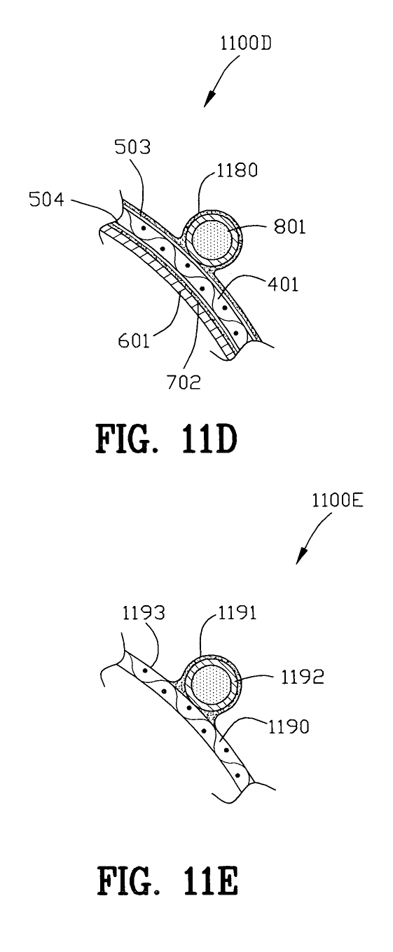

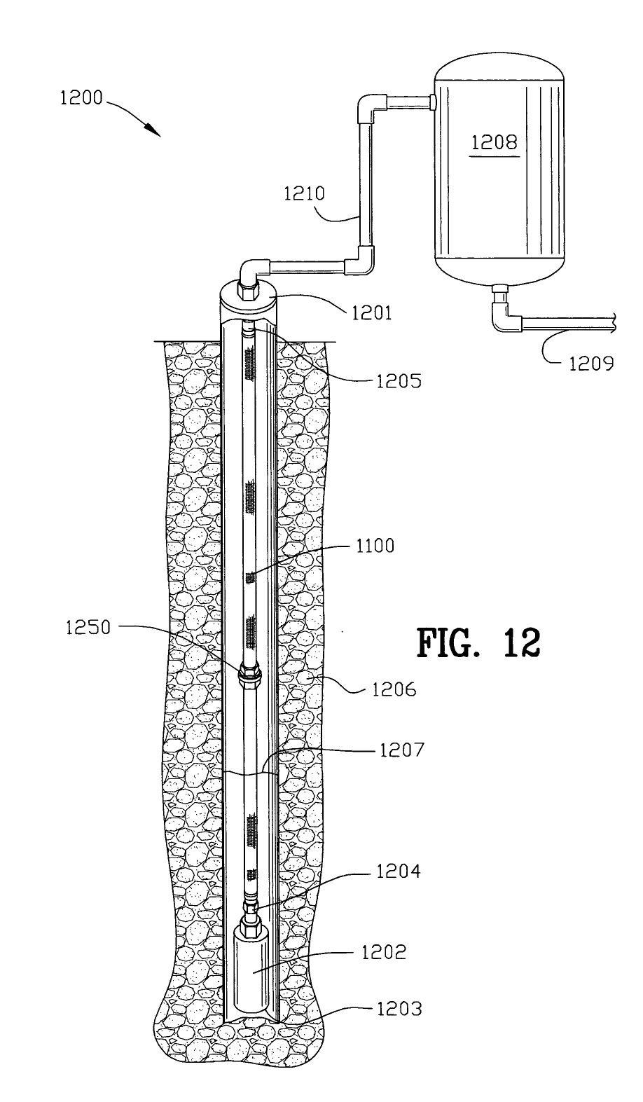

FIG. 11 is a perspective view 1100 of the inner tube, the polyurethane tube, and the outer jacket secured with the conductors affixed between the adhesive on the exterior of the tube and the outer jacket. This view illustrates the composite hose. FIG. 11A is a top view 1100A of FIG. 11 and illustrates the conductors embedded in the adhesive.

FIG. 11B is a front view of FIG. 11. FIG. 11C is an enlargement of a portion of FIG. 11A illustrating the polyurethane inner tube or liner 601, heat-activated adhesive 702 between the polyurethane tube 601 and the conductors and between the polyurethane tube 601 and the outer jacket 401. FIG. 11C also illustrates the latex sealant layers 503, 504.

FIG. 12 is an illustration 1200 of the hose 1100 used in combination with a well casing 1201 and a well pump 1202 in a well 1206. Connector 1204 connects hose 1100 to pump 1202 and connector 1205 connects hose 1100 to the upper flange at the top of the casing. Water within pump casing 1201 is indicated by reference numeral 1207. Water is taken in the pump through pump suction 1203 at the bottom of pump 1202 and is raised within hose 1100, piping 1210 and into surge tank 1208 where it is stored for usage by load 1209.

Referring to FIG. 11A, water within the hose does not contact any of the conductors whether or not they are insulated. The polyurethane tube 601 is an insulator as indicated in FIG. 11C.

FIG. 3A is an illustration 300A of the process steps for manufacturing another embodiment of the present invention. FIG. 3A includes the step 310 of passing the composite hose through adhesive to affix wires to the exterior of the composite hose. This can be accomplished by extruding a thermoplastic material such as polyurethane or polyethylene on the exterior of the composite hose. FIG. 11D is a cross-sectional view 1100D of another embodiment of composite hose made by the process illustrated in FIG. 3A illustrating a thermoplastic adhesive 1180 applied over conductors 801 on the exterior of a composite hose. The composite hose includes, as discussed before, a polyurethane or polyethylene liner applied to a woven outer jacket. A conductor (or a plurality of conductors) such as conductor 801 is/(are) secured to the exterior of the outer woven jacket 401 by a thermoplastic adhesive applied by an extruder.

FIG. 3B is an illustration 300B of the process steps for manufacturing another embodiment of the present invention. This process includes affixing 311 wires to the outside of a woven outer jacket 1190. Outer woven jacket 1190 is a through the weave extrusion having a thin lining of approximately 0.035 inches. This embodiment includes the step of passing 312 the woven outer jacket through a secondary extruder to apply molten polyurethane selectively over just the wires. FIG. 11E is a cross-sectional view 1100E of another embodiment of composite hose made by the process illustrated in FIG. 3B illustrating hot-melted polyurethane or polyethylene 1191 bonding 1193 the wires 1192 to the outside of the hose 1190. Polyurethane or polyethylene is applied just over the wire or wires by an extruder designed to extrude locally over the wires. Multiple wires may be employed as set forth in previous figures and in this description above and they can be located in proximity with each other.

FIG. 12A illustrates hose union 1200A which enables joinder of two sections of hose 1250, 1256. Hose section 1250 includes conductors 1251 and 1252 which mate with conductor receptacles 1255, 1254 respectively. Conductors 1257, 1258 electrically communicate with receptacles 1254, 1255 respectively. Threaded member 1253 is affixed to hose section 1250 and threaded member 1262 rotates with respect to hose member 1256 and stop 1260. Seal 1261 prevents water from escaping.

As mentioned before, a plurality of conductors may be used in the hose. Wire diameter size and material is a function of ampacity needed to drive the pump motor. Additionally, larger diameter wire can be used and a larger number or wires may be used to counteract the torque of the pump motor to maintain the hose in an untwisted condition.

The composite hose as set forth in FIG. 11A, for example, may be produced in different sizes for use in different diameter wells. Most wells will utilize hose having diameters of 4, 6 or 8 inches but other sizes are specifically contemplated.

It will be understood by those of skill in the art that the invention has been described by way of example only and that changes may be made to the invention without departing from the spirit and scope of the appended claims.

1. A hose comprising: an inner tube having an inside and an outside; adhesive affixed to said outside of said inner tube; at least one electrical conductor embedded in said adhesive; an outer woven jacket; and, said inner tube secured to said outer woven jacket.

2. A hose as claimed in claim 1 wherein said electrical conductor is an insulated conductor.

3. A hose as claimed in claim 1 wherein said outer jacket is woven and a latex coating is applied onto, into and through the outer jacket.

4. A hose as claimed in claim 1 wherein said inner tube is a polyurethane tube.

5. A hose as claimed in claim 1 wherein said adhesive is a heat activated adhesive.

6. A process for making a hose comprising the steps of:
weaving the outer jacket,
applying latex coating onto, into and through the outer jacket;
removing excess coating from said coated outer jacket;
curing said coated outer jacket;
forming a polyurethane tube;
applying adhesive to the exterior of the polyurethane tube;
attaching conductors to the polyurethane tube;
inserting the polyurethane tube in said outer jacket; and,
applying steam to the interior of said polyurethane tube.

7. A process for making a hose as claimed in claim 6 wherein the step of applying the adhesive includes spraying said adhesive onto a laid-flat polyurethane hose.

8. A process for making a hose as claimed in claim 6 wherein the step of applying the adhesive includes rolling the adhesive onto a laid-flat polyurethane hose.

9. A water pumping system comprising:
a hose, said hose comprising:
an inner tube having an inside and an outside; adhesive affixed to said outside of said inner tube; at least one electrical conductor embedded in said adhesive; an outer woven jacket; and, said inner tube and said at least one electrical conductor secured to said outer woven jacket;
a pump having an electric motor, and, said electric motor of said pump being connected to said at least one electrical conductor of said hose.

10. A water pumping system as claimed in claim 9 wherein said adhesive is heat activated.

11. A water pumping system as claimed in claim 9 wherein said inner tube is heated and expands radially outwardly, said adhesive being heat activated and securing said inner tube to said outer woven jacket.

12. A water pumping system as claimed in claim 11 wherein said inner tube is made of polyurethane.

13. A water pumping system as claimed in claim 9 wherein a plurality of conductors are embedded in said adhesive.

14. A water pumping system as claimed in claim 9 wherein a plurality of non-insulated conductors are embedded in said adhesive.

15. A well water system comprising a well casing, an electric well pump and a water hose affixed to said electric well pump for evacuating water from said well casing, said water hose includes a plurality of electrical conductors residing on the inside of said hose, said plurality of electrical conductors powering said electric well pump.

16. A well water system as claimed in claim 15 wherein said water hose comprises a polyurethane inner tube having an interior and an exterior, adhesive affixed to said exterior of said inner tube; said plurality of electrical conductors embedded in said adhesive; an outer woven jacket sealed with a latex-based sealant; and, said exterior of inner tube and said plurality of electrical conductors secured to said outer woven jacket.

17. A well water system as claimed in claim 16 wherein said adhesive is heat activated.

18. A hose comprising: an inner tube having an interior and an exterior; adhesive affixed to said outside of said inner tube; an outer woven jacket having an interior and an exterior; said exterior or said inner tube secured to said interior of said outer woven jacket; and, at least one conductor adhesively affixed to said exterior of said outer woven jacket.

19. A hose as claimed in claim 18 wherein a plurality of conductors are adhesively affixed to said exterior of said woven outer jacket.

20. A hose, comprising: a woven jacket having an exterior and an interior; said interior of said hose exposed to fluids conducted therein; and, at least one conductor affixed to said exterior of said woven jacket by polyurethane hot melt bonded locally to said conductor and said exterior of said woven jacket.

21. A hose as claimed in claim 20 wherein a plurality of conductors are affixed to said exterior of said woven jacket.

22. A hose as claimed in claim 20 wherein polyethylene is hot melt bonded to said conductor and said exterior of said woven jacket.

23. A hose as claimed in claim 22 wherein a plurality of conductors are affixed to said exterior of said woven jacket.

24. A process for making a hose comprising the steps of:
weaving the outer jacket,
applying latex coating onto, into and through the outer jacket;
removing excess coating from said coated outer jacket;
curing said coated outer jacket;
forming a polyurethane tube;
applying adhesive to the exterior of the polyurethane tube;
inserting the polyurethane tube in said outer jacket;
applying steam to the interior of said polyurethane tube;
passing the composite hose through a thermoplastic material; and,
affixing wires to said composite hose.

25. A process for making a hose comprising the steps of:
weaving a jacket,
applying latex coating onto, into and through the woven jacket;
affixing wires to the outside of the woven jacket; and,
passing the woven jacket through a secondary extruder to apply a thermoplastic material over said wires to secure said wires to said outer woven jacket.

26. A process for making hose as claimed in claim 25 wherein polyethylene is selectively extruded by said secondary extruder to affix said wires.

27. A process for making a hose as claimed in claim 25 wherein a polyurethane is selectively extruded by said secondary extruder to affix said wires.

28. A well water system comprising a well casing, an electric well pump and a water hose affixed to said electric well pump for evacuating water from said well casing, said water hose includes an interior and an exterior; a plurality of electrical conductors residing on and adhesively affixed to said exterior of said hose, and, said plurality of electrical conductors powering said electric well pump.

29. A water well system as claimed in claim 28 wherein said adhesive is a thermoplastic adhesive.
